(19) United States
(12) Patent Application Publication
(10) Pub. No.: US 2024/0347744 A1
(43) Pub. Date: Oct. 17, 2024

(54) FUEL CELL SYSTEM FOR PERFORMANCE RECOVERY AND OPERATION METHOD THEREOF

(71) Applicants: Hyundai Motor Company, Seoul (KR); Kia Corporation, Seoul (KR)

(72) Inventors: Seung Man Park, Anyang (KR); Jae Kwan Bae, Seoul (KR); Seung Ho Shin, Yongin (KR)

(21) Appl. No.: 18/231,635

(22) Filed: Aug. 8, 2023

(30) Foreign Application Priority Data
Apr. 13, 2023 (KR) 10-2023-0048901

(51) Int. Cl. H01M 8/04089; H01M 8/04858; H01M 8/22

(52) U.S. Cl. CPC H01M 8/04089; H01M 8/0488; H01M 8/0491; H01M 8/22; B60L 50/72; H01M 2250/20

(57) ABSTRACT

A fuel cell system includes a fuel cell stack that generates power by using a reactive gas, and a controller operatively connected to the fuel cell stack and performing a catalyst refresh operation on the fuel cell stack. The controller is configured to determine whether to perform the catalyst refresh operation, by calculating an oxide film amount for the fuel cell stack, to update at least part of parameters used to calculate the oxide film amount based on a state of the fuel cell stack, and to use the updated parameter so as to calculate the oxide film amount.

### CROSS-REFERENCE TO RELATED APPLICATION

This application claims under 35 U.S.C. § 119(a) the benefit of Korean Patent Application No. 10-2023-0048901, filed in the Korean Intellectual Property Office on Apr. 13, 2023, the entire contents of which are incorporated herein by reference.

### BACKGROUND

### (a) Technical Field

The present disclosure relates to performance recovery of a fuel cell system, more particularly, to the fuel cell system for adjusting a timing of removing an oxide film based on a state of a fuel cell stack, and a performance recovery operation method thereof.

### (b) Description of the Related Art

A fuel cell system is a power generation device that converts chemical energy generated by electrochemical reaction of a reactive gas (e.g., a fuel gas and an oxidizing gas) into electrical energy. The fuel cell system may be used to supply power to small electrical/electronic products and portable devices, in addition to serving as a power source for industrial, household, and vehicle use.

A fuel cell system typically includes a fuel cell stack composed of a plurality of unit cells. The unit cells may include a polymer electrolyte membrane, a membrane electrode assembly having an air electrode (e.g., a cathode) and a fuel electrode (e.g., an anode), which are catalyst electrode layers coated with a catalyst such that a reactive gas (e.g., a fuel gas or an oxidizing gas) is capable of reacting on both sides of the electrolyte membrane, a gas diffusion layer that supplies the reactive gas to the membrane electrode assembly and delivers electrical energy, a gasket and a fastening tool that maintain airtightness of the reactive gas and the coolant and proper fastening pressure, and a bipolar plate that moves the reactive gas and the coolant.

Performance of a fuel cell stack typically decreases as the operating time of the fuel cell stack increases. For example, platinum (Pt) may be used as a catalyst of the fuel cell stack (e.g., a catalyst electrode layer), and an oxide film may be formed on a surface of a platinum catalyst due to continued operation of the fuel cell stack. An effective area of the platinum catalyst may be reduced by this oxide film, and as a result, the power generation performance of the fuel cell stack may deteriorate.

In this regard, the fuel cell system may remove an oxide film formed on the surface of the platinum catalyst by performing a catalyst refresh operation of lowering a driving voltage (e.g., a cell voltage) of the fuel cell stack to a reduction voltage of a specific level. Accordingly, the power generation performance of the fuel cell stack may be recovered.

However, oxidation and reduction reactions may be repeated by the catalyst refresh operation. When the oxidation and reduction reactions occur frequently, platinum loss may be caused by elution of platinum in an ionic state.

Furthermore, to ensure durability of the catalyst electrode layer, an oxide film having a specific level should be formed on the platinum catalyst surface. However, when the oxide film formed on the surface of the platinum catalyst through the catalyst refresh operation is maintained at the specific level or less, the durability of the electrode layer may be lowered.

### SUMMARY

An aspect of the present disclosure provides a fuel cell system for adjusting an oxide film removal time point based on an oxide film amount of a catalyst layer, and a performance recovery operation method thereof.

An aspect of the present disclosure provides a fuel cell system for updating an oxide film amount calculation parameter depending on a state of a fuel cell stack in calculating the oxide film amount, and a performance recovery operation method thereof.

An aspect of the present disclosure provides a fuel cell system for updating the oxide film amount calculation parameter when the state of the fuel cell stack satisfies a specified condition, and a performance recovery operation method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell system includes a fuel cell stack that generates power by using a reactive gas, and a controller operatively connected to the fuel cell stack and performing a catalyst refresh operation on the fuel cell stack. The controller is configured to determine whether to perform the catalyst refresh operation, by calculating an oxide film amount for the fuel cell stack, to update at least part of parameters used to calculate the oxide film amount based on a state of the fuel cell stack, and to use the updated parameter so as to calculate the oxide film amount.

According to various embodiments, the controller may be configured to update the parameter based on at least one of an amount of an oxide film formed on the fuel cell stack, a temperature, or relative humidity.

According to various embodiments, the parameter may include at least one of transfer coefficient (α), exchange current density (i₀), or limit current density (i_{L}).

According to various embodiments, the controller may be configured to update at least part of the parameter based on the state of the fuel cell stack when the fuel cell stack satisfies a specified condition, and to exclude the update operation when the fuel cell stack does not satisfy the specified condition.

According to various embodiments, the specified condition may include at least one of an operation, an operation resume, an idle stop, or a pause release of the fuel cell stack.

According to various embodiments, the controller may be configured to continuously update at least part of the parameter based on the state of the fuel cell stack while the fuel cell stack is operating.

According to various embodiments, the controller may be configured to update a catalyst refresh potential based on an oxide film amount calculated in an operation state of the fuel cell stack.

According to various embodiments, the controller may be configured to calculate a residual film amount according to the catalyst refresh operation based on a predetermined catalyst refresh potential and the calculated oxide film amount, and to update a potential at a point in time, at which the residual film amount decreases to be less than a specified film amount, to the catalyst refresh potential.

According to an aspect of the present disclosure, an operating method of a fuel cell system includes calculating an oxide film amount for a fuel cell stack and determining whether to perform a catalyst refresh operation, based on the oxide film amount. The operating method of the fuel cell system further includes updating at least part of parameters used to calculate the oxide film amount based on a state of the fuel cell stack, and using the updated parameter(s) to calculate the oxide film amount.

According to various embodiments, the operating method of the fuel cell system may further include updating the parameter(s) based on at least one of an amount of an oxide film formed on the fuel cell stack, a temperature, or relative humidity.

According to various embodiments, the parameter(s) may include at least one of transfer coefficient (α), exchange current density (i₀), or limit current density (i_{L}).

According to various embodiments, the controller may be configured to calculate the transfer coefficient (α) and the exchange current density (i₀) after setting a concentration overpotential of each of a first region (P₁) and a second region (P₂) on a voltage-current characteristic curve (IV curve) indicating current and voltage characteristics of the fuel cell stack to a value of ‘0’, to calculate a concentration overpotential of a third region (P₃) on the voltage-current characteristic curve by using the calculated transfer coefficient (α) and the calculated exchange current density (i₀), and to correct the concentration overpotential of each of the first region (P₁) and the second region (P₂) by using the concentration overpotential of the third region (P₃).

According to various embodiments, the first region (P₁) and the second region (P₂) may be some of a current region where activation overpotential is dominant. The third region (P₃) may be some of a current region where concentration overpotential is dominant.

According to various embodiments, a vehicle may include the fuel cell system.

According to various embodiments, a fuel cell vehicle may include the fuel cell system.

According to various embodiments, the operating method of the fuel cell system may further include updating at least part of the parameters based on the state of the fuel cell stack when the fuel cell stack satisfies a specified condition, and excluding the updating when the fuel cell stack does not satisfy the specified condition.

According to various embodiments, the specified condition may include at least one of an operation, an operation resume, an idle stop, or a pause release of the fuel cell stack.

According to various embodiments, the operating method of the fuel cell system may further include continuously updating at least part of the parameters based on the state of the fuel cell stack while the fuel cell stack is operating.

According to various embodiments, the operating method of the fuel cell system may further include updating a catalyst refresh potential based on an oxide film amount calculated in an operation state of the fuel cell stack.

According to various embodiments, the operating method of the fuel cell system may further include calculating a residual film amount according to the catalyst refresh operation based on a predetermined catalyst refresh potential and the calculated oxide film amount, and updating a potential at a point in time, at which the residual film amount decreases to be less than a specified film amount, to the catalyst refresh potential.

According to various embodiments, the operating method of the fuel cell system may further include calculating the transfer coefficient (α) and the exchange current density (i₀) after setting a concentration overpotential of each of a first region (P₁) and a second region (P₂) on a voltage-current characteristic curve (IV curve) indicating current and voltage characteristics of the fuel cell stack to a value of ‘0’, calculating a concentration overpotential of a third region (P₃) on the voltage-current characteristic curve by using the calculated transfer coefficient (α) and the calculated exchange current density (i₀), and correcting the concentration overpotential of each of the first region (P₁) and the second region (P₂) by using the concentration overpotential of the third region (P₃).

According to various embodiments, the first region (P₁) and the second region (P₂) may be some of a current region where activation overpotential is dominant. The third region (P₃) may be some of a current region where concentration overpotential is dominant.

### BRIEF DESCRIPTION OF THE DRAWINGS

The above and other objects, features and advantages of the present disclosure will be more apparent from the following detailed description taken in conjunction with the accompanying drawings:

FIG. 1A is a block diagram illustrating a configuration of a fuel cell system, according to various embodiments;

FIG. 1B is a flow diagram for describing a fuel cell stack, according to various embodiments;

FIGS. 2A-2B are graphs, and FIG. 2C is a table listing exemplary values for describing an operation of a fuel cell system, according to various embodiments;

FIG. 3 is a flowchart illustrating an operation of a fuel cell system, according to various embodiments;

FIG. 4 is a flowchart illustrating a catalyst refresh operation of a fuel cell system, according to various embodiments;

FIG. 5 is a flowchart illustrating a parameter update operation of a fuel cell system, according to various embodiments; and

FIG. 6 is a block diagram illustrating a configuration of a computing system performing a method, according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the accompanying drawings. In adding reference numerals to components of each drawing, it should be noted that the same components have the same reference numerals, although they are indicated on another drawing. Furthermore, in describing the embodiments of the present disclosure, detailed descriptions associated with well-known functions or configurations will be omitted when they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

A fuel cell system mentioned in the following description may be used as a power source of a vehicle. However, this is one of various embodiments, and the present disclosure is not limited thereto. For example, a fuel cell system according to various embodiments may be used as an industrial power source, a household power source, a power source for a small electrical/electronic product, or a power source for a portable device.

Moreover, a vehicle referred to in the following description may be an eco-friendly vehicle provided with a motor as a power source, and may include a vehicle operated by a driver's boarding and/or manipulation, and an autonomous vehicle having a self-driving function without a driver's manipulation. In addition, in the following description, a car is described as an example of a vehicle, but the present disclosure is not limited thereto. For example, various embodiments below may be applied to various means of transportation such as a ship, an airline, a train, a motorcycle, or a bicycle.

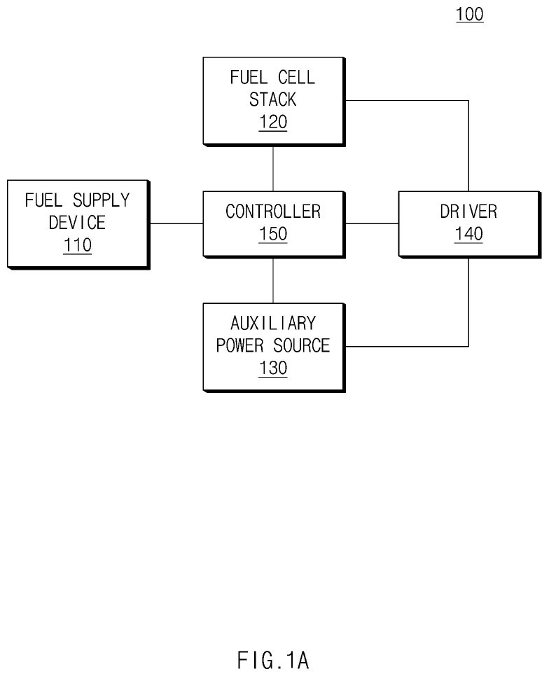

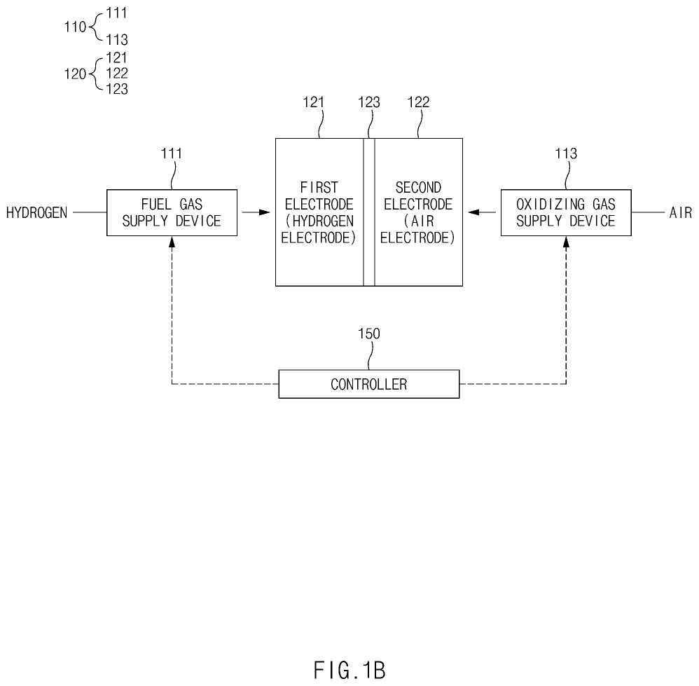

Hereinafter, various embodiments of the present disclosure will be described in detail with reference to FIGS. 1A to 6.

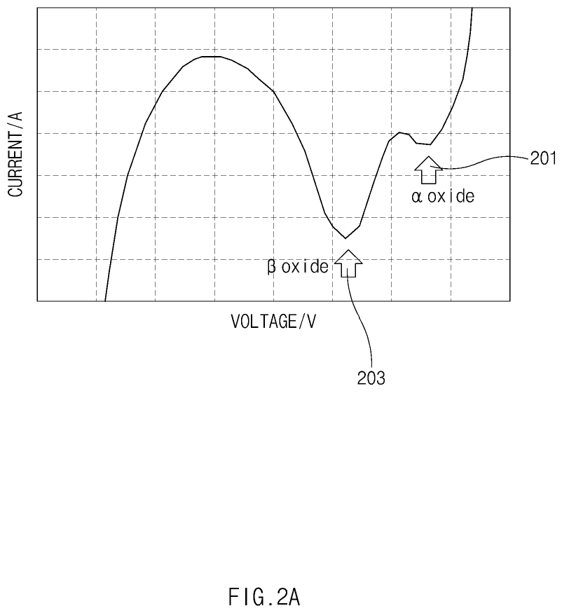

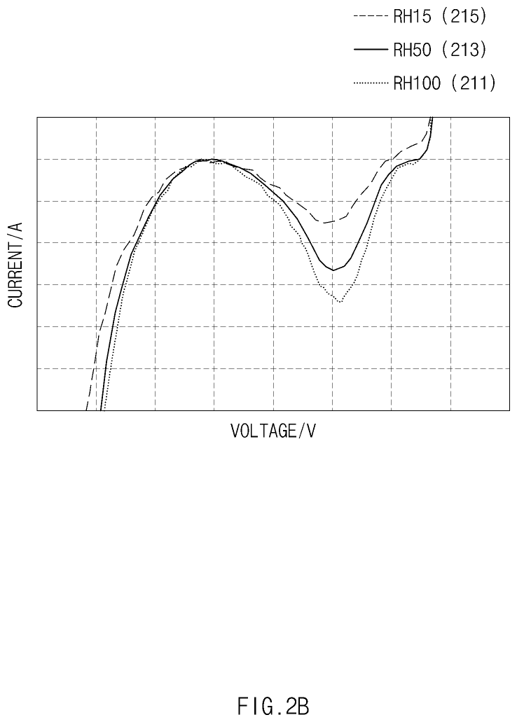

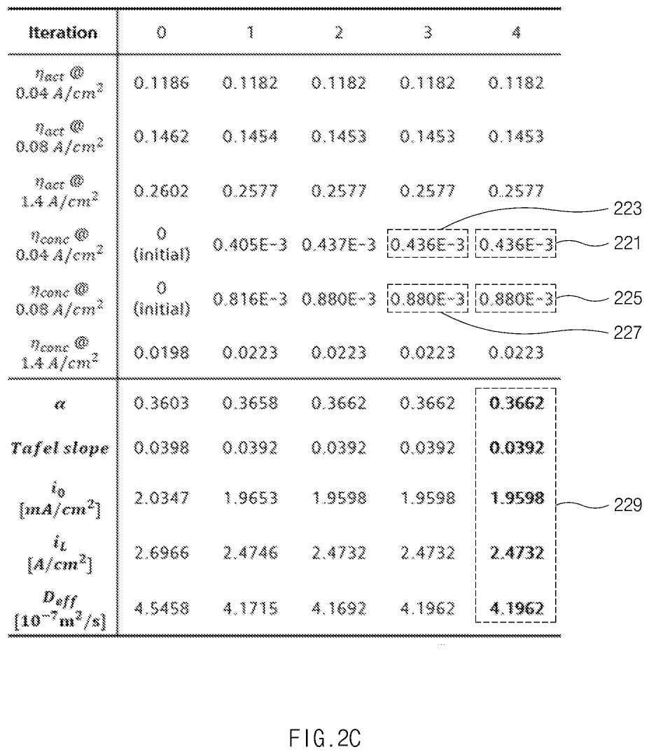

FIG. 1A is a block diagram illustrating a configuration of a fuel cell system, according to various embodiments. Moreover, FIG. 1B is a flow diagram for describing a fuel cell stack, according to various embodiments, and FIGS. 2A and 2B are graphs, and FIG. 2C is a table listing exemplary values for describing an operation of a fuel cell system, according to various embodiments.

Referring to FIGS. 1A and 1B, a fuel cell system 100 according to various embodiments may include a fuel supply device 110, a fuel cell stack 120, an auxiliary power source 130, a driver 140, and a controller 150.

However, this is only an example, and various embodiments are not limited thereto. For example, at least one of the above-described components of the fuel cell system 100 may be omitted. For example, the auxiliary power source 130 may be omitted from a configuration of the fuel cell system 100. In addition, at least one other component may be added to the configuration of the fuel cell system 100 in addition to the above-described components, and at least one of the above-described components may be integrated with another component.

According to various embodiments, the fuel supply device 110 may be configured to supply a reactive gas to the fuel cell stack 120. The reactive gas may include a fuel gas and an oxidizing gas. According to an embodiment, the fuel supply device 110 may include a fuel gas supply device 111 configured to supply the fuel gas to the fuel cell stack 120, and an oxidizing gas supply device 113 configured to supply the oxidizing gas to the fuel cell stack 120. For example, the fuel gas may include hydrogen, and the oxidizing gas may include air.

According to various embodiments, the fuel cell stack 120 may generate power by using the reactive gas supplied from the fuel supply device 110. For example, the fuel cell stack 120 may be formed by stacking a plurality of cells (e.g., unit cells), and may generate power by using an electrochemical reaction of the reactive gas.

According to an embodiment, each of the cells may be composed of a membrane electrode assembly in which a catalyst electrode layer is attached to both sides of the electrolyte membrane 123. Besides, a catalyst electrode layer attached to both sides of the membrane 123 may include a first electrode 121 (e.g., a fuel electrode, a hydrogen electrode, or an anode), to which the fuel gas is supplied and which causes an oxidation reaction, and a second electrode 122 (e.g., an air electrode or a cathode), to which the oxidizing gas is supplied and which causes a reduction reaction. For example, the first electrode 121 and the second electrode 122 may be composed of an electrode layer (Pt/C) having Pt supported on carbon.

However, this is only an example, and various embodiments are not limited thereto. For example, each of the cells may have a structure including a gas diffusion layer that supplies the reactive gas to the membrane electrode assembly and delivers electrical energy, a gasket and a fastening tool that maintain the airtightness of the reactive gas and coolant and proper fastening pressure, and a bipolar plate that moves the reactive gas and the coolant.

According to various embodiments, the auxiliary power source 130 may include a high-voltage battery capable of being charged/discharged. According to an embodiment, the auxiliary power source 130 may be used as a storage source of surplus power, a regenerative energy storage source during regenerative braking, or the like.

According to various embodiments, the driver 140 may be driven by an output (e.g., three-phase AC voltage) of the fuel cell stack 120 or the auxiliary power source 130, and may generate power for driving a vehicle. According to an embodiment, the driver 140 may include a driving motor. For example, the power generated by the driver 140 may be delivered to an axle via the transmission device and the differential gear device. Accordingly, a wheel is rotated by the axle, and thus the vehicle is driving. The transmission device, the differential gear device, the axle, and the wheel are known through many documents, and a detailed description thereof will be omitted throughout this document.

According to various embodiments, the controller 150 may be operatively connected to the above-described components (e.g., the fuel supply device 110, the fuel cell stack 120, the auxiliary power source 130, and the driver 140) of the fuel cell system 100 and may control the overall operation of the fuel cell system 100.

According to an embodiment, the controller 150 may control the termination of operation of the fuel cell stack 120, and the start of operation of the fuel cell stack 120. Moreover, the controller 150 may distribute and control outputs of the fuel cell stack 120 and the auxiliary power source 130. For example, the controller 150 may control an operation of the fuel cell stack 120 by controlling (e.g., controlling the supply of each of the fuel gas and the oxidizing gas) the supply of the fuel gas and the supply of the oxidizing gas.

According to an embodiment, the controller 150 may control a catalyst refresh operation of removing an oxide film formed on a surface of a platinum catalyst.

As described above, the power generation performance of the fuel cell stack 120 may be degraded by an oxide film formed on the platinum catalyst surface of the catalyst electrode layer (e.g., the first electrode 121 or the second electrode 122).

In this regard, the controller 150 may remove at least part of the oxide film formed on the surface of the platinum catalyst by performing a catalyst refresh operation of lowering the driving voltage (e.g., a cell voltage) of the fuel cell stack 120 to the reduction voltage.

According to an embodiment, the controller 150 may continuously or periodically calculate the amount of oxide film formed on the surface of the platinum catalyst, and may perform the catalyst refresh operation based on at least part of the calculated oxide film amount. For example, the catalyst refresh operation may be performed when an oxide film of a specific amount or more is formed on the surface of the platinum catalyst. In this regard, the controller 150 may calculate an oxide film amount with reference to Equation 1 to Equation 3 and Table 1 to Table 3 below. Equation 1 to Equation 3 may be equations obtained by applying the concept of an oxide film amount to Butler-Volmer equation.

$$[ Equation 1 ]$$

$${R}_{𝒪𝒳} = {k}_{𝒪𝒳} [ exp ( - \frac{{ω}_{pto} {θ}_{pto}}{RT} ) exp ( \frac{{α}_{a} {n}_{𝒪𝒳} F}{RT} ( ϕ - {ϕ}_{eq , 𝒪𝒳} ) ) - {{θ}_{pto} ( \frac{{c}_{H +}}{{c}_{H +}^{ref}} )}^{2} exp ( - \frac{{α}_{c} {n}_{𝒪𝒳} F}{RT} ( {α}_{c} {n}_{𝒪𝒳} F ) ) ]$$

TABLE 1
Parameter description for Equation 1

R_{OX}: Oxide film formation reaction rate [mol/cm²s], Calculated value
k_{OX}: Oxide film formation reaction rate constant [mol/cm²s], 1.4 × 10⁻¹¹
ωₚₜₒ: PtO interaction parameter [J/mol], Unknown
θₚₜₒ: Oxide film coverage [—], Calculated value
αₐ: Air electrode transfer cooefficient [—], Unknown
α_{c}: Fuel electrode transfer cooefficient [—], Unknown
n_{OX}: Number of reactive electrons [—], 2
F: Faraday constant [As/mol], 96485.3
ϕ: Potential [V], Variable
ϕ_{eq, OX}: oxide film formation equilibrium potential [V], Calculated value
c_{H+}: H⁺ concentration [mol/cm³], Calculated value
c_{H+}^{ref}: Reference H⁺ concentration [mol/cm³], Assume Know, 1.0 × 10⁻³

$$[ Equation 2 ]$$

$${ϕ}_{eq , 𝒪𝒳} = {ϕ}_{eq , 𝒪𝒳}^{ref} - \frac{{Δμ}_{Pt}}{2 F} + \frac{{Δμ}_{PtO}}{2 F} , \\ {Δμ}_{Pt} = \frac{{σ}_{Pt} {M}_{Pt}}{{r}_{Pt} {σ}_{Pt}} , {Δμ}_{PtO} = {Δμ}_{PtO}^{ref} + \frac{{σ}_{PtO} {M}_{PtO}}{{r}_{Pt} {σ}_{PtO}}$$

TABLE 2
Parameter description for Equation 2

ϕ_{eq, OX}: Oxide film formation equilibrium potential [V], Calculated value
ϕ_{eq, OX}^{ref}: Reference oxide film formation equilibrium
potential [V], Assume Know, 098
Δμ_{Pt}: Pt Chemical potential [J/mol], Calculated value
σ_{Pt}: Pt surface tension [J/cm²], 0.237 × 10⁻³
M_{Pt}: Pt molar mass [g/cm²], 195.084
r_{Pt}: Pt particle radius mass [cm], Variable, Assume to be 2 nm
Δμ_{PtO}: PtO Chemical potential [J/mol], Calculated value
Δμ_{PtO}^{ref}: Reference PtO Chemical potential [J/mol], Assume - 42.3
σ_{PtO}: PtO surface tension [J/cm²], 0.1 × 10⁻³
M_{PtO}: PtO molar mass [g/cm²], 227.08

$$[ Equation 3 ]$$

$${C}_{{H}^{+}} = \frac{1}{\frac{EW}{{ρ}_{n α fion}} + \frac{λ {M}_{{H}_{2} O}}{{ρ}_{{H}_{2} O}}} \\ λ = 0.043 + 17.81 {α}_{w} - 39.85 {α}_{w}^{2} + 36. {α}_{w}^{3} , \\ Nafion - 117 , ( 0 \leq {α}_{w} \leq 1 , unsaturate )$$

TABLE 3
Parameter description for Equation 3

EW: Equivalent weight of nafion [g/mol], Assume Know, 1110
ρ_{nαfion}: Nafion density [g/cm³], Assume Know, 1.96
λ: water content, number of mole molecules per SO₃⁻H⁺, Calculated value
M_{H}_{₂}_{O}: water molecule molar mass [g/mol], 18.01528
ρ_{H}_{₂}_{O}: water molecule density [g/cm_{³}_{], 1}
α_{w}: relative humidity [—], ], Variable

Furthermore, the oxide film amount (e.g., a limit oxide film amount θ_{Pt0,lim}) in a chemical equilibrium state (i.e., when the reaction rate is zero) in which the rate of oxidation reaction is the same as the rate of reduction reaction may be calculated through Equation 4 below.

$$[ Equation 4 ]$$

$${R}_{𝒪𝒳} = {k}_{𝒪𝒳} [ exp ( - \frac{{ω}_{pto} {θ}_{pto}}{RT} ) exp ( \frac{{α}_{a} {n}_{𝒪𝒳} F}{RT} ( ϕ - {ϕ}_{eq , 𝒪𝒳} ) ) - {{θ}_{pto} ( \frac{{c}_{H +}}{{c}_{{H}^{+}}^{ref}} )}^{2} exp ( - \frac{{α}_{c} {n}_{𝒪𝒳} F}{RT} ( {α}_{c} {n}_{𝒪𝒳} F ) ) ] = 0$$

$${θ}_{pto , lim} = \frac{RT}{{ω}_{pto}} W ( {( \frac{{c}_{H +}}{{c}_{{H}^{+}}^{ref}} )}^{2} \frac{{ω}_{pto}}{RT} exp ( \frac{( {α}_{a} + {α}_{c} ) {Fn}_{𝒪𝒳} ( ϕ - {ϕ}_{eq , 𝒪𝒳} )}{RT} ) )$$

At least part of the oxide film may be removed from a platinum catalyst surface by this catalyst refresh operation, thereby recovering the power generation performance of the fuel cell stack 120 to a specific level or higher. However, platinum loss may be caused by elution of platinum in an ionic state by iteration of oxidation and reduction reactions caused by the catalyst refresh operation.

Moreover, while the catalyst refresh operation is performed, an oxide film removal amount may vary depending on the state of the fuel cell stack 120.

For example, as shown in FIG. 2A, a first oxide film 201 (e.g., α-oxide) and a second oxide film 203 (e.g., β-oxide) may be formed on the catalyst electrode layer (e.g., the first electrode 121 and the second electrode 122). The first oxide film 201 is a film capable of being removed by the driving voltage of the fuel cell stack 120 corresponding to the first reduction voltage. The second oxide film 203 may be a film capable of being removed by the driving voltage of the fuel cell stack 120 corresponding to a second reduction voltage lower than the first reduction voltage.

Furthermore, as shown in FIG. 2B, it may be seen that the amount of film removed (e.g., an oxide film removal amount) varies depending on the state of the fuel cell stack 120 corresponding to a first humidity 211 (e.g., RH 100), a second humidity 213 (e.g., RH 50), and a third humidity 215 (e.g., RH 15) even when the catalyst refresh operation is performed. In other words, at relatively high first humidity 211, the reduction reaction rate may increase. At the relatively low third humidity 215, the reduction reaction rate may decrease.

In other words, to ensure the durability of the catalyst electrode layer, an oxide film having a specific level needs to be formed (or maintained) on the surface of the platinum catalyst. However, when the catalyst refresh operation is performed in a state where the calculation accuracy for an oxide film amount is not greater than a specific level or a state where the state of the fuel cell stack 120 is not considered, the durability of the catalyst electrode layer may deteriorate.

As described below, the controller 150 according to various embodiments may update a value of at least one parameter among parameters used to calculate the amount of an oxide film based on the state of the fuel cell stack 120, thereby improving the accuracy of oxide film amount calculation and improving the durability of the catalyst electrode layer.

In describing specific embodiments of updating parameters used to calculate the coating amount, as identified through Equation 1 to Equation 4, various parameters may be used to calculate the oxide film amount.

According to an embodiment, at least one of the various parameters used to calculate the oxide film amount may have a constant value regardless of the state of the fuel cell stack 120. At least another parameter thereof may have a value changed depending on the state of the fuel cell stack 120. In the description below, a parameter having a constant value regardless of the state of the fuel cell stack 120 is referred to as a “fixed parameter”. A parameter has a value changed depending on the state of the fuel cell stack 120 are referred to as a “variable parameter”. Furthermore, it may be understood that the variable parameter is a parameter affecting current and voltage characteristics of the fuel cell stack 120.

For example, Faraday constant (F), gas constant (R), or the like which are identified through Equation 1 and Equation 4 above may be a fixed parameters that are not affected by the state of the fuel cell stack 120. Transfer coefficient (α), exchange current density (i₀), and limit current density (i_{L}) may be variable parameters that are affected by the state of the fuel cell stack 120.

According to an embodiment, the state (e.g., amount of current oxide film formed on the surface of a platinum catalyst, temperature and relative humidity of the fuel cell stack 120, or the like) of the fuel cell stack 120 may be continuously changed in an operating state. For example, the oxide film amount may increase or decrease in a state where the fuel cell stack 120 is operating, and the temperature and humidity of the fuel cell stack 120 may increase or decrease depending on the temperature and humidity of the surrounding environment. Accordingly, a value of the variable parameter also needs to be changed.

As such, when the variable parameter is not continuously updated in response to the state of the fuel cell stack 120, it is impossible to calculate the amount of oxide film for guaranteeing the accuracy having a specific level.

In this regard, according to various embodiments, the controller 150 may periodically or continuously update a value of at least one variable parameter to a value corresponding to the state of the fuel cell stack 120 and then may calculate an oxide film amount by using the value, thereby improving the calculation accuracy of oxide film amount. In this regard, the controller 150 may determine the value of the variable parameter by combining calculation formulas in Equation 5 and parameters described in Table 4 below.

$$[ Equation 5 ]$$

$$Transfer cooefficient , {α}_{a} , {α}_{c} \\ α = {α}_{a , c} = \frac{RT}{Tafel slope \cdot {nF}^{′}} {η}_{act} = - ( \frac{RT}{α nF} ) ln {i}_{0} + ( \frac{RT}{α nF} ) ln i \\ {η}_{ohim} = {iR}_{ohim} , {η}_{conc} = ( \frac{RT}{nF} ) ( 1 + \frac{1}{α} ) ln [ \frac{{i}_{L}}{{i}_{L} - i} ] , \\ {i}_{L} = \frac{{nFD}_{eff} {C}_{B}^{0}}{δ} , \\ {C}_{B}^{0} = 0.21 \frac{P \cdot γ}{RT} , {η}_{total} = {η}_{act} + {η}_{ohim} + {η}_{conc} , \\ E ( i ) = {E}_{OCV} - {η}_{total} ( i )$$

TABLE 4
Parameter description for Equation 5

η_{act}: activation overpotential [V], Calculated value
ηₒₕᵢₘ: ohmic overpotential [V], Calculated value
η_{conc}: concentration overpotential [V], Calculated value
ηₜₒₜₐₗ: total overpotential [V], Calculated value
i₀: Exchange current density [A/cm²], Unknow
i_{L}: Limit current density [A/cm²], ], Calculated value
i: Current density [A/cm²], Variable
Rₒₕᵢₘ : ohm resistance, incl. junction resistance & proton conductivity [Ω],
know by HFR
D_{eff}: Effective diffusion cooefficient of O₂ [cm²/s], Unknow
C_{B}0: Bulk concentration of O₂ [mol/cm²], Calculated value
δ: Thickness [cm], Assume to be 100 μm
P: pressure [Pa], variable
γ: Cathode stoichiometry ratio [—], variable
α: Transfer cooefficient, αₐ α_{c}, Assume to be same [—], Unknow

According to an embodiment, in determining the value of the variable parameter (e.g., transfer coefficient (α), exchange current density (i₀), and limit current density (i_{L})), the controller 150 may use IV data for at least three regions on a voltage-current characteristic curve (IV curve) indicating current and voltage characteristics of the fuel cell stack 120. It is assumed that values of three types of variable parameters are determined. When values of two types of variable parameters are determined, IV data for two regions on the voltage-current characteristic curve may be used.

For example, at least three regions on the voltage-current characteristic curve may include a first region (P₁) and a second region (P₂), each of which corresponds to a low-current region, and a third region (P₃) corresponding to a high-current region. For example, the low-current region may be part of a current region (e.g., 0.01A/cm²˜0.1A/cm²) in which activation overpotential is dominant. The high-current region may be part of a current region (e.g., 1.0A/cm²˜1.8A/cm²) in which the concentration overpotential is dominant.

According to an embodiment, the controller 150 may calculate transfer coefficient (α) and exchange current density (i₀) through at least one or a combination of two or more of the calculation formulas described in the above-described Equation 5.

For example, the transfer coefficient (α) may be derived through Equation 6 below.

$$[ Equation 6 ]$$

$$α = ( \frac{RT}{nF} ) \cdot ( \frac{ln {i}^{{P}_{2}} - ln {i}^{{P}_{1}}}{{η}_{act}^{{P}_{2}} - {η}_{act}^{{P}_{1}}} )$$

In Equation 6 above, η_{act}^{P}^{₁} denotes the activation overpotential (e.g., first activation overpotential) of the first region (P₁); η_{act}^{P}^{₂} denotes the activation overpotential (e.g., second activation overpotential) of the second region (P₂); i^{P}^{₁} denotes a current density (e.g., first current density) in the first region (P₁); i^{P}^{₂} denotes a current density (e.g., second current density) in the second region (P₂); ‘R’ denotes a gas constant; and, ‘T’ denotes the temperature of the fuel cell stack 120.

In this regard, in the controller 150, it may be assumed that the concentration overpotential (e.g., first concentration overpotential) of the first region (P₁) and the concentration overpotential (e.g., second concentration overpotential) of the second region (P₂) do not actually occur.

For example, it is assumed that each of the first reference concentration overpotential η_{conc}^{P}^{₁} for the first region (P₁) and the second reference concentration overpotential η_{conc}^{P}^{₂} for the second region (P₂) have a value of 0. The controller 150 may calculate the first activation overpotential η_{act}^{P}^{₁} through calculation formula (1) described in Equation 7 below, and may calculate the second activation overpotential η_{act}^{P}^{₂} through calculation formula (2) described in Equation 7 below.

$$[ Equation 7 ]$$

$${η}_{act}^{{P}_{1}} = {η}_{total}^{{P}_{1}} - {η}_{ohimc}^{{P}_{1}} = - ( \frac{RT}{α nF} ) ln {i}_{0} + ( \frac{RT}{α nF} ) ln {i}^{{P}_{1}} \qquad ( 1 )$$

$${η}_{act}^{{P}_{2}} = {η}_{total}^{{P}_{2}} - {η}_{ohimc}^{{P}_{2}} = - ( \frac{RT}{α nF} ) ln {i}_{0} + ( \frac{RT}{α nF} ) ln {i}^{{P}_{2}} \qquad ( 2 )$$

Besides, the controller 150 may calculate exchange current density (i₀) by using the transfer coefficient (α) derived through Equation 6 and calculation formula (1) for deriving the first activation overpotential η_{act}^{P}^{₁} described in Equation 7 above. For example, the controller 150 may calculate the exchange current density (i₀) by substituting the calculated transfer coefficient (α) into calculation formula (1).

According to an embodiment, the controller 150 may calculate the third concentration overpotential η_{act}^{P}^{₃} for the third region (P₃) by using the transfer coefficient (α) and the exchange current density (i₀) calculated through Equation 6 and Equation 7 above, and may calculate third limit current density i_{L}^{P}^{₃} for the third region (P₃) by using the calculated result. In this regard, the controller 150 may calculate the third limit current density i_{L}^{P}^{₃} by substituting the transfer coefficient (α) and the exchange current density (i₀) into Equation 8 below,

$$[ Equation 8 ]$$

$${η}_{conc}^{{P}_{3}} = {η}_{total}^{{P}_{3}} - {η}_{ohimc}^{{P}_{3}} - {η}_{act}^{{P}_{3}} = ( \frac{RT}{nF} ) ( 1 + \frac{1}{α} ) ln [ \frac{{i}_{L}^{{P}_{3}}}{{i}_{L}^{{P}_{3}} - {i}^{{P}_{3}}} ]$$

In Equation 8 above, ηₜₒₜₐₗ^{P}^{₃} denotes the overall overpotential for the third region (P₃); η_{act}^{P}^{₃} act denotes the activation overpotential for the third region (P₃); η_{ohimc}^{P}^{₃} denotes the ohmic overpotential for the third region (P₃); and, i^{P}^{₃} denotes the current density in the third region (P₃).

According to an embodiment, the controller 150 may calculate an updated first concentration overpotential η_{updated_conc}^{P1} for the first region (P₁) and an updated second concentration overpotential η_{updated_conc}^{P2} for the second region (P₂), by using the third limit current density i_{L}^{P}^{₃} derived through Equation 8, and may verify first transfer coefficient (α), first exchange current density (i₀), and third limit current density (i_{L}) based on the calculated result. For example, the controller 150 may calculate the updated first concentration overpotential η_{updated_conc}^{P1} and the updated second concentration overpotential η_{updated_conc}^{P2} by using Equation 9 below.

$$[ Equation 9 ]$$

$${η}_{updated \_ conc}^{P 1} = ( \frac{RT}{nF} ) ( 1 + \frac{1}{α} ) ln [ \frac{{i}_{L}^{1}}{{i}_{L}^{1} - {i}^{1}} ]$$

$${η}_{updated \_ conc}^{P 2} = ( \frac{RT}{nF} ) ( 1 + \frac{1}{α} ) ln [ \frac{{i}_{L}^{2}}{{i}_{L}^{2} - {i}^{2}} ]$$

According to an embodiment, when the updated first concentration overpotential is equal to the first reference concentration overpotential and the updated second concentration overpotential is equal to the second reference concentration overpotential (e.g., when verification is successful), the controller 150 may use transfer coefficient (α), exchange current density (i₀), and third limit current density (i_{L})) as variable parameter values.

Also, when the updated first concentration overpotential is different from first reference concentration overpotential, or when the updated second concentration overpotential is different from second reference concentration overpotential (e.g., when verification fails), the controller 150 may repeatedly perform an operation of calculating transfer coefficient (α), exchange current density (i₀), and third limit current density (i_{L}).

At this time, the controller 150 may use the above-described Equation 5 to Equation 8 by using the updated first concentration overpotential as the first reference concentration overpotential and using the updated second concentration overpotential as the second reference concentration overpotential. For example, as shown in FIG. 2C, the controller 150 may use values 229 of transfer coefficient (α), exchange current density (i₀), and third limit current density (i_{L}) as variable parameter values at a point in time when updated first concentration overpotential 221 is equal to first reference concentration overpotential 223, and updated second concentration overpotential 225 is equal to second reference concentration overpotential 227.

As described above, according to various embodiments, the controller 150 may periodically or continuously update a value of at least one variable parameter to a value corresponding to the state of the fuel cell stack 120 and then may calculate an oxide film amount by using the value, thereby improving the accuracy of oxide film amount calculation and improving the durability of the catalyst electrode layer.

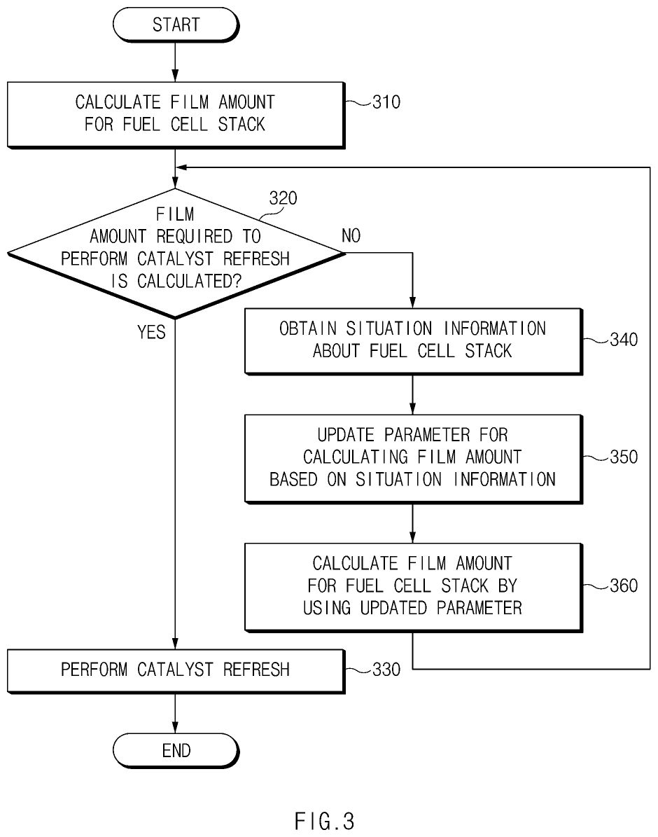

Hereinafter, an operating method of the fuel cell system 100 according to various embodiments will be described with reference to FIGS. 3 to 5.

FIG. 3 is a flowchart illustrating an operation of a fuel cell system, according to various embodiments. Hereinafter, each operation in the following embodiments may be sequentially performed, but is not necessarily sequentially performed. For example, the order of operations may be changed, and at least two operations may be performed in parallel. Also, at least one of the following operations may be omitted according to an embodiment.

Referring to FIG. 3, in operation 310, the fuel cell system 100 (e.g., the controller 150) according to various embodiments may calculate an oxide film amount for the fuel cell stack 120. According to an embodiment, the fuel cell system 100 may calculate the amount of oxide film formed on a platinum catalyst surface.

According to various embodiments, in operation 320, the fuel cell system 100 (e.g., the controller 150) may determine whether the oxide film amount required to perform a catalyst refresh is calculated. According to an embodiment, the fuel cell system 100 may determine whether an oxide film having a predetermined amount or more is formed on the surface of the platinum catalyst.

According to various embodiments, when the film amount required to perform catalyst refresh is calculated, in operation 330, the fuel cell system 100 (e.g., the controller 150) may perform a catalyst refresh operation. According to an embodiment, the fuel cell system 100 may perform the catalyst refresh operation of lowering a driving voltage (e.g., a cell voltage) of the fuel cell stack 120 to a predetermined catalyst refresh potential (e.g., a reduction voltage). Accordingly, at least part of the oxide film may be removed from the surface of the platinum catalyst, thereby recovering the power generation performance of the fuel cell stack 120.

According to various embodiments, when the film amount that is not required to perform the catalyst refresh operation is calculated, like operation 340 to operation 360, the fuel cell system 100 (e.g., the controller 150) may update at least one parameter used to calculate the oxide film amount based on the state of the fuel cell stack 120, and then may calculate an oxide film amount by using the updated parameter.

According to an embodiment, transfer coefficient (α), exchange current density (i₀), and limit current density (i_{L}), which are used to calculate the oxide film amount may be variable parameters affected by the state of the fuel cell stack 120. As such, the fuel cell system 100 may continuously or periodically update a value of the variable parameter to a parameter value corresponding to the state of the fuel cell stack 120, and then may calculate the oxide film amount by using the updated parameter value.

In this regard, in operation 340, the fuel cell system 100 may obtain state information (e.g., the amount of current oxide film formed on the surface of platinum catalyst, temperature and relative humidity, or the like) about the fuel cell stack 120. Furthermore, in operation 350, the fuel cell system 100 may update the value of at least one variable parameter based on at least part of the state information. For example, the fuel cell system 100 may update the variable parameter value with reference to at least part of above-described Equation 5 to Equation 9.

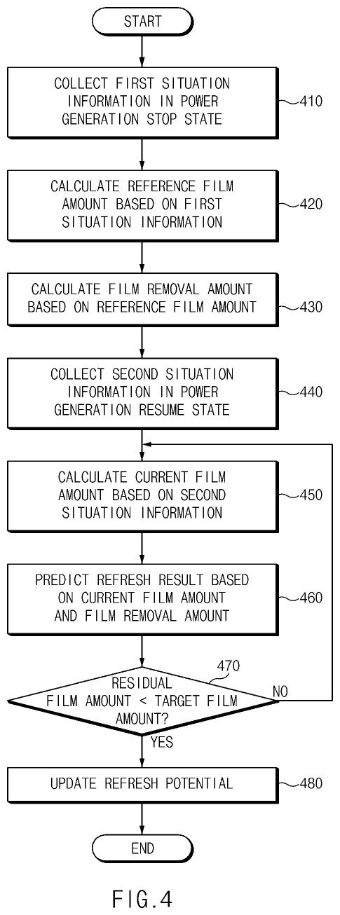

FIG. 4 is a flowchart illustrating a catalyst refresh operation of a fuel cell system, according to various embodiments. Operations of FIG. 4 described below may indicate various embodiments of operation 330 of FIG. 3. Moreover, each of operations in an embodiment below may be performed sequentially, or the order of the operations may be changed. Furthermore, at least two operations of the following operations may be performed in parallel, and at least one operation may be omitted according to an embodiment.

Referring to FIG. 4, according to various embodiments, in operation 410, the fuel cell system 100 (e.g., the controller 150) may collect first situation information in a power generation stop state (e.g., an operation stop state) of the fuel cell stack 120. According to an embodiment, the fuel cell system 100 may obtain various parameters necessary to calculate an oxide film amount as at least part of the first situation information. For example, an open circuit voltage, humidity, a temperature, or the like may be obtained as the first situation information.

According to various embodiments, in operation 420, the fuel cell system 100 (e.g., the controller 150) may calculate a reference oxide film amount based on the first situation information. The reference oxide film amount may be related to the amount of oxide film formed in the fuel cell stack 120 in the power generation stop state. For example, the fuel cell system 100 may calculate the reference oxide film amount based on an average potential of the fuel cell stack 120 in the power generation stop state. In this regard, the fuel cell system 100 may calculate the reference oxide film amount with reference to above-mentioned Equation 1 to Equation 3 or Equation 4.

According to various embodiments, in operation 430, the fuel cell system 100 (e.g., the controller 150) may calculate an oxide film removal amount, which is capable of being removed through a catalyst refresh operation, based on the reference oxide film amount. According to an embodiment, when a catalyst refresh operation is performed at the present time point, the oxide film removal amount may be the amount of oxide film capable of being removed from the reference oxide film amount. For example, the fuel cell system 100 may calculate the oxide film removal amount based on the execution time (e.g., the time to maintain the preset catalyst refresh potential) of the catalyst refresh operation.

According to various embodiments, in operation 440, the fuel cell system 100 (e.g., the controller 150) may collect second situation information in a power generation resume state (e.g., an operation resume state) of the fuel cell stack 120. According to an embodiment, the fuel cell system 100 may obtain various parameters required to calculate the amount of oxide film formed on the fuel cell stack 120 in the power generation resume state. For example, the humidity or temperature of the fuel cell stack 120 may be obtained as the second situation information.

According to various embodiments, in operation 450, the fuel cell system 100 (e.g., the controller 150) may calculate a current oxide film amount based on the second situation information. The current oxide film amount may be related to the amount of oxide film formed in the fuel cell stack 120 in the power generation resume state. For example, the fuel cell system 100 may calculate the current oxide film amount with reference to above-mentioned Equation 1 to Equation 3 or Equation 4.

According to various embodiments, in operation 460, the fuel cell system 100 (e.g., the controller 150) may predict the result of the catalyst refresh operation based on the current oxide film amount and the oxide film removal amount. According to an embodiment, when the catalyst refresh operation is performed at the present time point, the fuel cell system 100 may estimate the amount of oxide film, which remains on a platinum catalyst surface and which is not removed by the catalyst refresh operation. For example, the predicted result of the catalyst refresh operation may be a difference value between the current film amount and the oxide film removal amount.

According to various embodiments, in operation 470, the fuel cell system 100 (e.g., the controller 150) may determine whether a residual oxide film amount less than a target film amount is predicted. The target film amount may be defined as the amount of oxide film that needs to be maintained to ensure durability of the catalyst electrode layer having a specific level or higher.

According to various embodiments, when the residual oxide film amount more than the target film amount is predicted, the fuel cell system 100 (e.g., the controller 150) may re-perform an operation of calculating the current oxide film amount. In this case, while changing the preset catalyst refresh potential (e.g., a reduction voltage), the fuel cell system 100 may reduce the residual oxide film amount. In other words, while increasing the catalyst refresh potential until the residual oxide film amount less than the target film amount is predicted, the fuel cell system 100 may remove the oxide film.

According to various embodiments, when the residual oxide film amount less than the target film amount is predicted, in operation 480, the fuel cell system 100 (e.g., the controller 150) may update a potential at the present time point to a catalyst refresh potential. According to an embodiment, the fuel cell system 100 may perform the catalyst refresh operation based on the updated catalyst refresh potential.

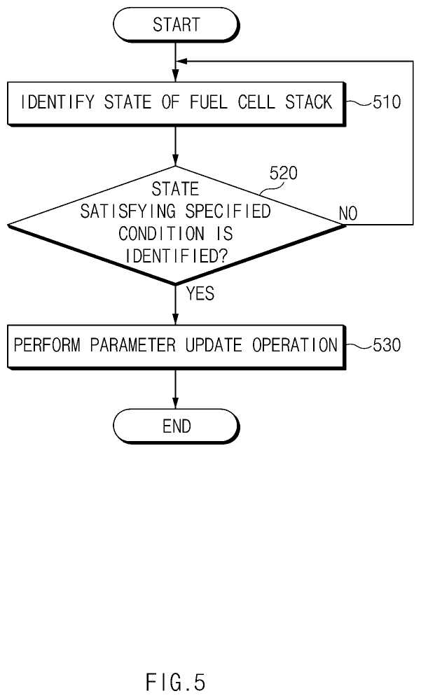

FIG. 5 is a flowchart illustrating a parameter update operation of a fuel cell system, according to various embodiments. Operations of FIG. 4 described below may represent various embodiments of at least one of operation 340 to operation 360 of FIG. 3. Moreover, each of operations in an embodiment below may be performed sequentially, or the order of the operations may be changed. Furthermore, at least two operations of the following operations may be performed in parallel, and at least one operation may be omitted according to an embodiment.

Referring to FIG. 5, in operation 510, the fuel cell system 100 (e.g., the controller 150) according to various embodiments may continuously or periodically identify a state of the fuel cell stack 120. According to an embodiment, the amount of oxide film currently formed on a platinum catalyst surface, temperature, and relative humidity may be related to the state of the fuel cell stack 120.

According to various embodiments, in operation 520, the fuel cell system 100 (e.g., the controller 150) may determine whether a state of the fuel cell stack 120 satisfying a specified condition is identified.

According to an embodiment, the state of the fuel cell stack 120 that satisfies the specified condition may include the operation stop state of the fuel cell stack 120, the operation resume state of the fuel cell stack 120, the idle stop (e.g., a pause) that temporarily stops the operation of the fuel cell stack 120, or the release state (e.g., a pause release) of the fuel cell stack 120.

According to various embodiments, when the state of the fuel cell stack 120 that does not satisfy the specified condition is identified, the fuel cell system 100 (e.g., the controller 150) may perform an operation of identifying the state of the fuel cell stack 120.

According to various embodiments, when the state of the fuel cell stack 120 that satisfies the specified condition is identified, in operation 530, the fuel cell system 100 (e.g., the controller 150) may perform a parameter update operation. In other words, when the state of the fuel cell stack 120 that does not satisfy the specified condition is identified, the execution of the parameter update operation may be excluded. The parameter update operation may be performed only when the state of the fuel cell stack 120 that does not satisfy the specified condition is identified.

As mentioned above, the fuel cell system 100 (e.g., the controller 150) according to various embodiments may perform a performance recovery operation related to FIGS. 3 to 5, thereby ensuring the performance of a fuel cell stack and durability of an electrode. Besides, the fuel cell system 100 according to various embodiments may perform a performance recovery operation of combining at least two of the above-described embodiments related to FIGS. 3 to 5.

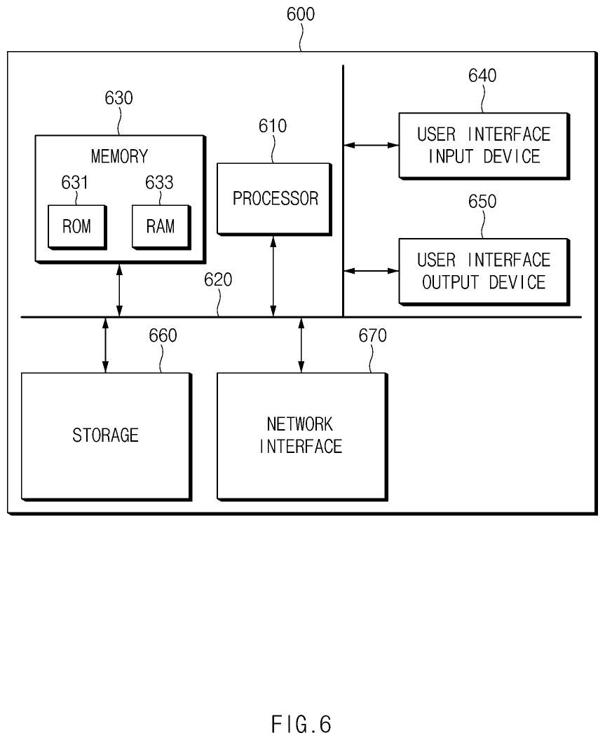

FIG. 6 is a block diagram illustrating a configuration of a computing system performing a method, according to an embodiment of the present disclosure.

Referring to FIG. 6, a computing system 600 may include at least one processor 610, a memory 630, a user interface input device 640, a user interface output device 650, a storage 660, and a network interface 670, which are connected with each other via a bus 620.

The processor 610 may be a central processing unit (CPU) or a semiconductor device that processes instructions stored in the memory 630 and/or the storage 660. Each of the memory 630 and the storage 660 may include various types of volatile or nonvolatile storage media. For example, the memory 630 may include a read only memory (ROM) 631 and a random access memory (RAM) 633.

Accordingly, the operations of the method or algorithm described in connection with the embodiments disclosed in the specification may be directly implemented with a hardware module, a software module, or a combination of the hardware module and the software module, which is executed by the processor 610. The software module may reside on a storage medium (i.e., the memory 630 and/or the storage 660) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM). The storage medium may be coupled to the processor 610. The processor 610 may read out information from the storage medium and may write information in the storage medium. Alternatively, the storage medium may be integrated with the processor 610. The processor 610 and storage medium may be implemented with an application specific integrated circuit (ASIC). The ASIC may be provided in a user terminal. Alternatively, the processor 610 and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Various embodiments disclosed in the specification may secure the performance of a fuel cell system and the durability of an electrode of a fuel cell stack by adjusting an oxide film removal time point (e.g., a point in time when catalyst refresh is performed) based on an oxide film amount of a catalyst layer.

Effects capable of being obtained in this specification are not limited to the above-mentioned effects.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fuel cell system comprising:
a fuel cell stack configured to generate power by using a reactive gas; and
a controller operatively connected to the fuel cell stack and configured to perform a catalyst refresh operation on the fuel cell stack,
wherein the controller is configured to:
determine whether to perform the catalyst refresh operation, by calculating an oxide film amount for the fuel cell stack;
update at least part of parameters used to calculate the oxide film amount based on a state of the fuel cell stack; and
use the updated at least part of the parameters so as to calculate the oxide film amount.

2. The fuel cell system of claim 1, wherein the controller is configured to:
update the at least part of the parameters based on at least one of an amount of an oxide film formed on the fuel cell stack, a temperature, or relative humidity.

3. The fuel cell system of claim 1, wherein the at least part of the parameters includes at least one of transfer coefficient (α), exchange current density (i₀), or limit current density (i_{L}).

4. The fuel cell system of claim 1, wherein the controller is configured to:
when the fuel cell stack satisfies a specified condition, update the at least part of the parameters based on the state of the fuel cell stack; and
when the fuel cell stack does not satisfy the specified condition, not update the at least part of the parameters.

5. The fuel cell system of claim 4, wherein the specified condition includes at least one of an operation, an operation resume, an idle stop, or a pause release of the fuel cell stack.

6. The fuel cell system of claim 1, wherein the controller is configured to:
while the fuel cell stack is operating, continuously update the at least part of the parameters based on the state of the fuel cell stack.

7. The fuel cell system of claim 1, wherein the controller is configured to:
update a catalyst refresh potential based on the oxide film amount calculated in an operation state of the fuel cell stack.

8. The fuel cell system of claim 7, wherein the controller is configured to:
calculate a residual film amount according to the catalyst refresh operation based on a predetermined catalyst refresh potential and the calculated oxide film amount; and
update a potential at a point in time, at which the residual film amount decreases to be less than a specified film amount, to the catalyst refresh potential.

9. The fuel cell system of claim 3, wherein the controller is configured to:
after setting a concentration overpotential of each of a first region (P₁) and a second region (P₂) on a voltage-current characteristic curve (IV curve) indicating current and voltage characteristics of the fuel cell stack to a value of ‘0’, calculate the transfer coefficient (α) and the exchange current density (i₀);
calculate a concentration overpotential of a third region (P₃) on the voltage-current characteristic curve by using the calculated transfer coefficient (α) and the calculated exchange current density (i₀); and
correct the concentration overpotential of each of the first region (P₁) and the second region (P₂) by using the concentration overpotential of the third region (P₃).

10. A vehicle comprising the fuel cell system of claim 1.

11. A fuel cell electric vehicle comprising the fuel cell system of claim 1.

12. An operating method of a fuel cell system, the operating method comprising:
calculating an oxide film amount for a fuel cell stack; and
determining whether to perform a catalyst refresh operation, based on the oxide film amount,
wherein determining whether to perform the catalyst refresh operation includes:
updating at least part of parameters used to calculate the oxide film amount based on a state of the fuel cell stack; and using the updated at least part of the parameters to calculate the oxide film amount.

13. The operating method of claim 12, wherein updating the at least part of the parameters includes:
updating the at least part of the parameters based on at least one of an amount of an oxide film formed on the fuel cell stack, a temperature, or relative humidity.

14. The operating method of claim 12, wherein the at least part of the parameters includes at least one of transfer coefficient (α), exchange current density (i₀), or limit current density (i_{L}).

15. The operating method of claim 12, wherein updating the at least part of the parameters used to calculate the oxide film amount based on a state of the fuel cell stack includes:
when the fuel cell stack satisfies a specified condition, updating the at least part of the parameters based on the state of the fuel cell stack; and
when the fuel cell stack does not satisfy the specified condition, not updating the at least part of the parameters.

16. The operating method of claim 15, wherein the specified condition includes at least one of an operation, an operation resume, an idle stop, or a pause release of the fuel cell stack.

17. The operating method of claim 12, wherein updating the at least part of the parameters includes: while the fuel cell stack is operating, continuously updating the at least part of the parameters based on the state of the fuel cell stack.

18. The operating method of claim 12, further comprising:
updating a catalyst refresh potential based on an oxide film amount calculated in an operation state of the fuel cell stack.

19. The operating method of claim 18, wherein updating the catalyst refresh potential includes:
calculating a residual film amount according to the catalyst refresh operation based on a predetermined catalyst refresh potential and the calculated oxide film amount; and
updating a potential at a point in time, at which the residual film amount decreases to be less than a specified film amount, to the catalyst refresh potential.

20. The operating method of claim 14, further comprising:
after setting a concentration overpotential of each of a first region (P₁) and a second region (P₂) on a voltage-current characteristic curve (IV curve) indicating current and voltage characteristics of the fuel cell stack to a value of ‘0’, calculating the transfer coefficient (α) and the exchange current density (i₀);
calculating a concentration overpotential of a third region (P₃) on the voltage-current characteristic curve by using the calculated transfer coefficient (α) and the calculated exchange current density (i₀); and
correcting the concentration overpotential of each of the first region (P₁) and the second region (P2) by using the concentration overpotential of the third region (P₃).
